(19) United States
(12) Patent Application Publication
(10) Pub. No.: US 2024/0429961 A1
(43) Pub. Date: Dec. 26, 2024

(54) RESIDUAL SIDEBAND CALIBRATION

(71) Applicant: Qualcomm Incorporated, San Diego, CA (US)

(72) Inventors: Shilei HAO, San Diego, CA (US); Dongling Pan, San Diego, CA (US); YIWU Tang, San Diego, CA (US)

(21) Appl. No.: 18/213,190

(22) Filed: Jun. 22, 2023

(51) Int. Cl. H04B 1/40

(52) U.S. Cl. CPC H04B 1/40

(57) ABSTRACT

Aspects of the present disclosure provide an integrated circuit (IC). The IC comprises oscillator systems each configured to generate a respective oscillating signal. The IC comprises signal paths each coupled to a respective one of the plurality of oscillator systems, a first one of the plurality of signal paths comprises a mixer, and another one comprises a tone generator. The tone generator is configured to generate a tone signal based on the oscillating signal from the corresponding oscillator system. The mixer is coupled to the tone generator of said another one of said plurality of signal paths and is configured to generate a mixed signal for RSB calibration based on the tone signal from the tone generator of said another one of the plurality of signal paths and the oscillating signal from the oscillator system coupled to said first one of said plurality of signal paths.

### TECHNICAL FIELD

Certain aspects of the present disclosure generally relate to integrated circuits in wireless communication devices, and, more particularly, to an integrated circuit for improving residual sideband (RSB) calibration of a radio frequency (RF) transmitter or receiver path.

### BACKGROUND

In modern transceiver systems implemented in wireless communication devices, local oscillators are used to generate frequency signals, which are used to convert a signal of interest (e.g., a data signal modulated in a specific way) to another frequency band using a mixer. Local oscillator and signal path mismatches cause I/Q gain and phase mismatch. The I/Q gain and phase mismatch increases the residual sideband (RSB) energy, which in turn degrades the transceiver system's signal to noise ratio (SNR). Inasmuch as modulation schemes tend to be complicated and become more complicated in the future, standard specifications for RSB require increased RSB calibration accuracy. Moreover, RSB calibration is generally inflexible when it comes to the speed of the process of calibration in different circumstances.

What is, thus, needed is a circuit and a method for RSB calibration which avoids the above deficiencies and improves the RSB calibration accuracy and/or the flexibility thereof.

### SUMMARY

Certain aspects of the present disclosure relate to an integrated circuit (IC), comprising a plurality of oscillator systems each configured to generate a respective oscillating signal, a plurality of signal paths each coupled to a respective one of the plurality of oscillator systems, a first one of the plurality of signal paths comprising a mixer, another one of the plurality of signal paths comprising a tone generator, the tone generator of the another one of said plurality of signal paths configured to generate a tone signal based on the oscillating signal from the corresponding oscillator system, the mixer of said first one of said plurality of signal paths coupled to the tone generator of said another one of said plurality of signal paths and configured to generate a mixed signal for RSB calibration based on the tone signal from the tone generator of said another one of the plurality of signal paths and the oscillating signal from the oscillator system coupled to said first one of said plurality of signal paths.

Certain aspects of the present disclosure relate to a method for residual sideband (RSB) calibration, comprising, generating by a plurality of oscillator systems a respective oscillating signal, wherein each of a plurality of signal paths is coupled to a respective one of the plurality of oscillator systems, a first one of the plurality of signal paths comprising a mixer, and another one of the plurality of signal paths comprising a tone generator, generating, by the tone generator of said another one of said plurality of signal paths, a tone signal based on the oscillating signal from the corresponding oscillator system, generating, by the mixer of said first one of the plurality of signal paths, a mixed signal based on the tone signal from the tone generator of the another one of said plurality of signal paths and the oscillating signal of the corresponding oscillating system; and performing RSB calibration of the first one of said plurality of signal paths based on the mixed signal.

Certain aspects of the present disclosure also relate to an apparatus. The apparatus generally includes in each of a plurality of oscillator systems, means for generating a respective oscillating signal. The apparatus further includes in each of a plurality of signal paths comprising a first one of the plurality of signal paths and another one of the plurality of signal paths, means for generating a tone signal based on the oscillating signal of the corresponding oscillator system, wherein each of the plurality of signal paths is coupled to a respective one of the plurality of the oscillator systems. The apparatus further includes means for mixing comprised in the first one of the plurality of signal paths, the tone signal of the another one of said plurality of signal paths with the oscillating signal of the corresponding oscillating system to generate a mixed signal; and means for performing RSB calibration of the first one of said plurality of signal paths based on the mixed signal.

### BRIEF DESCRIPTION OF THE DRAWINGS

FIG. 1 is a diagram showing a wireless device communicating with a wireless communication system.

FIG. 2A is a block diagram showing a wireless device in which exemplary techniques of the present disclosure may be implemented.

FIG. 2B is a block diagram showing a wireless device in which exemplary techniques of the present disclosure may be implemented.

FIG. 3 is an example for an integrated circuit for generating signals used for RSB calibration.

FIG. 4 is another example for an integrated circuit for generating signals used for RSB calibration.

FIG. 5 is an integrated circuit for generating signals for RSB calibration in accordance with a first aspect.

FIG. 6A is an integrated circuit for generating signals for RSB calibration in a time interleaved calibration mode at time T1 in accordance with a second aspect.

FIG. 6B is an integrated circuit for generating signals for RSB calibration in a time interleaved calibration mode at time T2 in accordance with the second aspect.

FIG. 7 is an integrated circuit for generating signals for RSB calibration in a frequency interleaved calibration mode in accordance with a third aspect.

FIG. 8 is an example for an integrated circuit in which RSB calibration can be implemented.

FIG. 9 is a flow chart describing an example of the operation of a method 900 for RSB calibration in accordance with a fourth aspect.

FIG. 10 is a functional block diagram of an apparatus in accordance with a fifth aspect.

FIG. 11 is an example for a tone generator used in various aspects.

### DETAILED DESCRIPTION

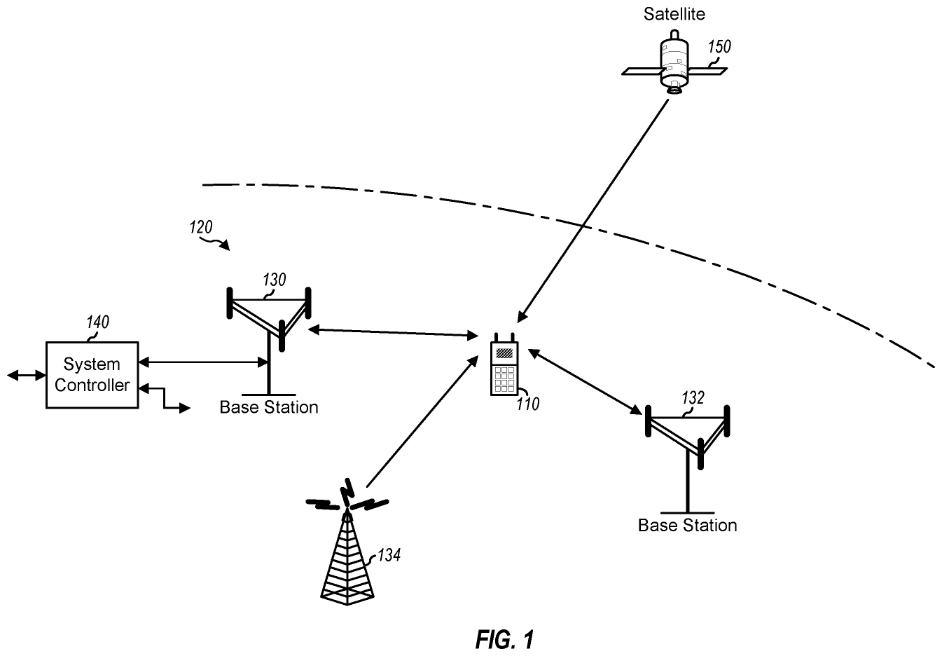

FIG. 1 is a diagram showing a wireless device 110 communicating with a wireless communication system 120. The wireless communication system 120 may be a Long Term Evolution (LTE) system, a Code Division Multiple Access (CDMA) system, a Global System for Mobile Communications (GSM) system, a wireless local area network (WLAN) system, a 5G NR (new radio) system, or some other wireless system. A CDMA system may implement Wideband CDMA (WCDMA), CDMA 1X, Evolution-Data Optimized (EVDO), Time Division Synchronous CDMA (TD-SCDMA), or some other version of CDMA. For simplicity, FIG. 1 shows wireless communication system 120 including two base stations 130 and 132 and one system controller 140. In general, a wireless communication system may include any number of base stations and any set of network entities.

The wireless device 110 may also be referred to as a user equipment (UE), a mobile station, a terminal, an access terminal, a subscriber unit, a station, etc. Wireless device 110 may be a cellular phone, a smartphone, a tablet, a wireless modem, a personal digital assistant (PDA), a handheld device, a laptop computer, a smartbook, a netbook, a tablet, a cordless phone, a medical device, an automobile, a device configured to connect to one or more other devices (for example through the internet of things), a wireless local loop (WLL) station, a Bluetooth device, etc. Wireless device 110 may communicate with wireless communication system 120. Wireless device 110 may also receive signals from broadcast stations (e.g., a broadcast station 134) and/or signals from satellites (e.g., a satellite 150 in one or more global navigation satellite systems (GNSS)), etc), and/or may transmit signals to one or more satellites. Wireless device 110 may support one or more radio technologies for wireless communication such as LTE, WCDMA, CDMA 1X, EVDO, TD-SCDMA, GSM, 802.11, 5G, etc.

Wireless device 110 may support carrier aggregation, for example as described in one or more LTE or 5G standards. In some embodiments, a single stream of data is transmitted over multiple carriers using carrier aggregation, for example as opposed to separate carriers being used for respective data streams. Wireless device 110 may be able to operate in a variety of communication bands including, for example, those communication bands used by LTE, WiFi, 5G or other communication bands, over a wide range of frequencies. Wireless device 110 may also be capable of communicating directly with other wireless devices without communicating through a network.

In general, carrier aggregation (CA) may be categorized into two types-intra-band CA and inter-band CA. Intra-band CA refers to operation on multiple carriers within the same band. Inter-band CA refers to operation on multiple carriers in different bands.

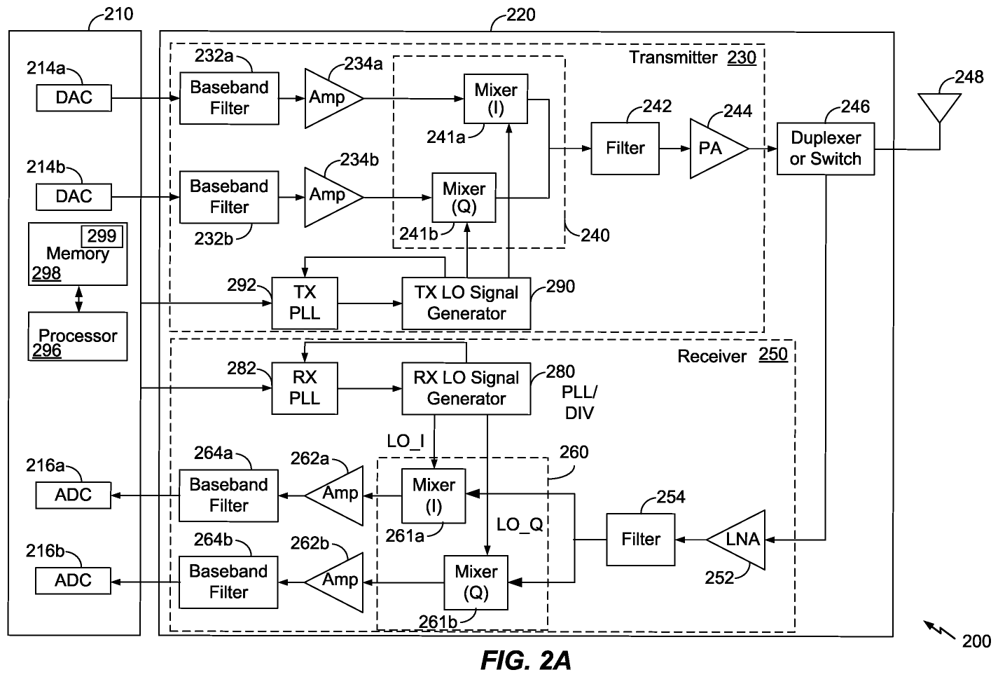

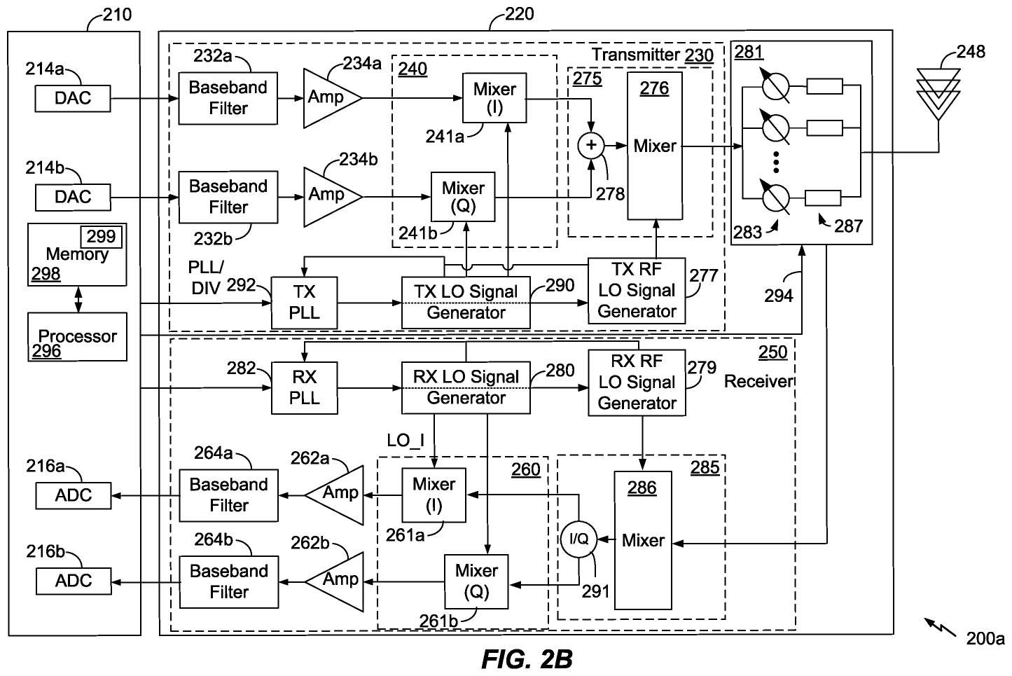

FIG. 2A is a block diagram showing a wireless device 200 in which exemplary techniques of the present disclosure may be implemented. The wireless device 200 may, for example, be an embodiment of the wireless device 110 illustrated in FIG. 1.

FIG. 2A shows an example of a transceiver 220 having a transmitter 230 and a receiver 250. In general, the conditioning of the signals in the transmitter 230 and the receiver 250 may be performed by one or more stages of amplifier, filter, upconverter, downconverter, etc. These circuit blocks may be arranged differently from the configuration shown in FIG. 2A. Furthermore, other circuit blocks not shown in FIG. 2A may also be used to condition the signals in the transmitter 230 and receiver 250. Unless otherwise noted, any signal in FIG. 2A, or any other figure in the drawings, may be either single-ended or differential. Some circuit blocks in FIG. 2A may also be omitted.

In the example shown in FIG. 2, wireless device 200 generally comprises the transceiver 220 and a data processor 210. The data processor 210 may include a processor 296 operatively coupled to a memory 298. The memory 298 may be configured to store data and program codes shown generally using reference numeral 299, and may generally comprise analog and/or digital processing components. The processor 296 and the memory 298 may cooperate to control, configure, program, or otherwise fully or partially control some or all of the operation of the embodiments of the systems and methods described herein. For example, the processor 296 may act as a mode controller which can switch the RSB calibration circuitry of the described aspects to a time interleaved calibration mode or to a frequency interleaved calibration mode as further detailed below. In another example, the mode controller may be partially or fully implemented in a digital portion (not shown) of the transceiver 220.

The transceiver 220 includes a transmitter 230 and a receiver 250 that support bi-directional communication. In general, wireless device 200 may include any number of transmitters and/or receivers for any number of communication systems and frequency bands. All or a portion of the transceiver 220 may be implemented on one or more analog integrated circuits (ICs), RF ICs (RFICs), mixed-signal ICs, etc.

A transmitter or a receiver may be implemented with a super-heterodyne architecture or a direct-conversion architecture. In the super-heterodyne architecture, a signal is frequency-converted between radio frequency (RF) and baseband in multiple stages, e.g., from RF to an intermediate frequency (IF) in one stage, and then from IF to baseband in another stage for a receiver. In the direct-conversion architecture, a signal is frequency converted between RF and baseband in one stage. The super-heterodyne and direct-conversion architectures may use different circuit blocks and/or have different requirements. In the example shown in FIG. 2, transmitter 230 and receiver 250 are implemented with the direct-conversion architecture.

In the transmit path, the data processor 210 processes data to be transmitted and provides in-phase (I) and quadrature (Q) analog output signals to the transmitter 230. In an exemplary embodiment, the data processor 210 includes digital-to-analog-converters (DAC's) 214a and 214b for converting digital signals generated by the data processor 210 into the I and Q analog output signals, e.g., I and Q output currents, for further processing. In other embodiments, the DACs 214a and 214b are included in the transceiver 220 and the data processor 210 provides data (e.g., for I and Q) to the transceiver 220 digitally.

Within the transmitter 230, baseband (e.g., lowpass) filters 232a and 232b filter the I and Q analog transmit signals, respectively, to remove undesired images caused by the prior digital-to-analog conversion. Amplifiers (Amp) 234a and 234b amplify the signals from baseband filters 232a and 232b, respectively, and provide I and Q baseband signals. An upconverter 240 having upconversion mixers 241a and 241b upconverts the I and Q baseband signals with I and Q transmit (TX) local oscillator (LO) signals from a TX LO signal generator 290 and provides an upconverted signal. A filter 242 filters the upconverted signal to remove undesired images caused by the frequency upconversion as well as noise in a receive frequency band. A power amplifier (PA) 244 amplifies the signal from filter 242 to obtain the desired output power level and provides a transmit RF signal. The transmit RF signal may be routed through a duplexer or switch 246 and transmitted via an antenna 248. While examples discussed herein utilize I and Q signals, those of skill in the art will understand that components of the transceiver may be configured to utilize polar modulation. Aspects described herein may be implemented in the transmitter 230, for example to enable RSB calibration in the transmitter. The transmitter may use a feedback receiver to do RSB calibration in two steps. In a first step, RSB calibration of the feedback receiver may be performed to ensure there is negligible gain and phase error from the feedback receiver. Negligible gain and phase error may promote transmitter RSB calibration accuracy. Aspects described herein may be implemented in this step. In a second step, the transmitter output may be downconverted to baseband through the feedback receiver, and the RSB calibration may be performed through baseband tone measurement and a RSB calibration unit, as further described in some examples below.

In the receive path, antenna 248 receives communication signals and provides a received RF signal, which may be routed through duplexer or switch 246 and provided to a low noise amplifier (LNA) 252. The duplexer 246 is designed to operate with a specific RX-to-TX duplexer frequency separation, such that RX signals are isolated from TX signals. The received RF signal is amplified by LNA 252 and filtered by a filter 254 to obtain a desired RF input signal.

Downconversion mixers 261a and 261b in a downconverter 260 mix the output of filter 254 with I and Q receive (RX) LO signals (i.e., LO_I and LO_Q) from an RX LO signal generator 280 to generate I and Q baseband signals. The I and Q baseband signals are amplified by amplifiers 262a and 262b and further filtered by baseband (e.g., lowpass) filters 264a and 264b to obtain I and Q analog input signals, which are provided to data processor 210. In the exemplary embodiment shown, the data processor 210 includes analog-to-digital-converters (ADC's) 216a and 216b for converting the analog input signals into digital signals to be further processed by the data processor 210. In some embodiments, the ADCs 216a and 216b are included in the transceiver 220 and provide data to the data processor 210 digitally. Aspects described herein may be implemented in the receiver 250, for example to enable RSB calibration in the receiver. In the RSB calibration, RSB is calibrated by generating a RSB calibration input tone which is mixed by downconverter 260 instead of the desired RF input signal to produce the I and Q baseband signals. The I and Q baseband signals are then forwarded to a RSB calibration unit which performs the RSB calibration for the receive path.

In FIG. 2A, TX LO signal generator 290 generates the I and Q TX LO signals used for frequency upconversion, while RX LO signal generator 280 generates the I and Q RX LO signals used for frequency downconversion. Each LO signal is a periodic signal with a particular fundamental frequency. A phase locked loop (PLL) 292 receives timing information from data processor 210 and generates a control signal used to adjust the frequency and/or phase of the TX LO signals from LO signal generator 290. Similarly, a PLL 282 receives timing information from data processor 210 and generates a control signal used to adjust the frequency and/or phase of the RX LO signals from LO signal generator 280.

Wireless device 200 may support CA and may (i) receive multiple downlink signals transmitted by one or more cells on multiple downlink carriers at different frequencies and/or (ii) transmit multiple uplink signals to one or more cells on multiple uplink carriers. Those of skill in the art will understand, however, that aspects described herein may be implemented in systems, devices, and/or architectures that do not support carrier aggregation.

Certain components of the transceiver 220 are functionally illustrated in FIG. 2, and the configuration illustrated therein may or may not be representative of a physical device configuration in certain implementations. For example, as described above, transceiver 220 may be implemented in various integrated circuits (ICs), RF ICs (RFICs), mixed-signal ICs, etc. In some embodiments, the transceiver 220 is implemented on a substrate or board such as a printed circuit board (PCB) having various modules, chips, and/or components. For example, the power amplifier 244, the filter 242, and the duplexer 246 may be implemented in separate modules or as discrete components, while the remaining components illustrated in the transceiver 220 may be implemented in a single transceiver chip.

The power amplifier 244 may comprise one or more stages comprising, for example, driver stages, power amplifier stages, or other components, that can be configured to amplify a communication signal on one or more frequencies, in one or more frequency bands, and at one or more power levels. Depending on various factors, the power amplifier 244 can be configured to operate using one or more driver stages, one or more power amplifier stages, one or more impedance matching networks, and can be configured to provide good linearity, efficiency, or a combination of good linearity and efficiency.

In an exemplary embodiment in a super-heterodyne architecture, the PA 244 and LNA 252 (and filter 242 and filter 254 in some examples) may be implemented separately from other components in the transmitter 230 and receiver 250, for example on a millimeter wave integrated circuit. An example super-heterodyne architecture is illustrated in FIG. 2B.

FIG. 2B is a block diagram showing a wireless device in which exemplary techniques of the present disclosure may be implemented. Certain components, for example which may be indicated by identical reference numerals, of the wireless device 200a in FIG. 2B may be configured similarly to those in the wireless device 200 shown in FIG. 2A and the description of identically numbered items in FIG. 2B will not be repeated.

The wireless device 200a is an example of a heterodyne (or superheterodyne) architecture in which the upconverter 240 and the downconverter 260 are configured to process a communication signal between baseband and an intermediate frequency (IF). For example, the upconverter 240 may be configured to provide an IF signal to an upconverter 275. In an exemplary embodiment, the upconverter 275 may comprise summing function 278 and upconversion mixer 276. The summing function 278 combines the I and the Q outputs of the upconverter 240 and provides a non-quadrature signal to the mixer 276. The non-quadrature signal may be single ended or differential. The mixer 276 is configured to receive the IF signal from the upconverter 240 and TX RF LO signals from a TX RF LO signal generator 277, and provide an upconverted RF signal to phase shift circuitry 281. While PLL 292 is illustrated in FIG. 2B as being shared by the signal generators 290, 277, a respective PLL for each signal generator may be implemented.

In an exemplary embodiment, components in the phase shift circuitry 281 may comprise one or more adjustable or variable phased array elements, and may receive one or more control signals from the data processor 210 over connection 294 and operate the adjustable or variable phased array elements based on the received control signals.

In an exemplary embodiment, the phase shift circuitry 281 comprises phase shifters 283 and phased array elements 287. Although three phase shifters 283 and three phased array elements 287 are shown for ease of illustration, the phase shift circuitry 281 may comprise more or fewer phase shifters 283 and phased array elements 287.

Each phase shifter 283 may be configured to receive the RF transmit signal from the upconverter 275, alter the phase by an amount, and provide the RF signal to a respective phased array element 287. Each phased array element 287 may comprise transmit and receive circuitry including one or more filters, amplifiers, driver amplifiers, and/or power amplifiers. In some embodiments, the phase shifters 283 may be incorporated within respective phased array elements 287.

The output of the phase shift circuitry 281 is provided to an antenna array 248. In an exemplary embodiment, the antenna array 248 comprises a number of antennas that typically correspond to the number of phase shifters 283 and phased array elements 287, for example such that each antenna element is coupled to a respective phased array element 287. In an exemplary embodiment, the phase shift circuitry 281 and the antenna array 248 may be referred to as a phased array.

In a receive direction, an output of the phase shift circuitry 281 is provided to a downconverter 285. In an exemplary embodiment, the downconverter 285 may comprise an I/Q generation function 291 and a downconversion mixer 286. In an exemplary embodiment, the mixer 286 downconverts the receive RF signal provided by the phase shift circuitry 281 to an IF signal according to RX RF LO signals provided by an RX RF LO signal generator 279. The I/Q generation function 291 receives the IF signal from the mixer 286 and generates I and Q signals for the downconverter 260, which downconverts the IF signals to baseband, as described above. While PLL 282 is illustrated in FIG. 2B as being shared by the signal generators 280, 279, a respective PLL for each signal generator may be implemented.

In some embodiments, the upconverter 275, downconverter 285, and the phase shift circuitry 281 are implemented on a common IC. In some embodiments, the summing function 278 and the I/Q generation function 291 are implemented separate from the mixers 276 and 286 such that the mixers 276, 286 and the phase shift circuitry 281 are implemented on the common IC, but the summing function 278 and I/Q generation function 291 are not (e.g., the summing function 278 and I/Q generation function 291 are implemented in another IC coupled to the IC having the mixers 276, 286). In some embodiments, the LO signal generators 277, 279 are included in the common IC. In some embodiments in which phase shift circuitry is implemented on a common IC with 276, 286, 277, 278, 279, and/or 291, the common IC and the antenna array 248 are included in a module, which may be coupled to other components of the transceiver 220 via a connector. In some embodiments, the phase shift circuitry 281, for example, a chip on which the phase shift circuitry 281 is implemented, is coupled to the antenna array 248 by an interconnect. For example, components of the antenna array 248 may be implemented on a substrate and coupled to an integrated circuit implementing the phase shift circuitry 281 via a flexible printed circuit.

In some embodiments, both the architecture illustrated in FIG. 2A and the architecture illustrated in FIG. 2B are implemented in the same device. For example, a wireless device 110 or 200 may be configured to communicate with signals having a frequency below about 20 GHz using the architecture illustrated in FIG. 2A and to communicate with signals having a frequency above about 20 GHz using the architecture illustrated in FIG. 2B. In devices in which both architectures are implemented, one or more components of FIGS. 2A and 2B that are identically numbered may be shared between the two architectures. For example, both signals that have been downconverted directly to baseband from RF and signals that have been downconverted from RF to baseband via an IF stage may be filtered by the same baseband filter 264. In other embodiments, a first version of the filter 264 is included in the portion of the device which implements the architecture of FIG. 2A and a second version of the filter 264 is included in the portion of the device which implements the architecture of FIG. 2B. While certain example frequencies are described herein, other implementations are possible. For example, signals having a frequency above about 20 GHZ (e.g., having a mmW frequency) may be transmitted and/or received using a direct conversion architecture. In such embodiments, for example, a phased array may be implemented in the direct conversion architecture.

A residual side band or RSB is generally a signal self-image caused by an I/Q imbalance of the mismatched, imperfect mixer. This RSB may be a signal having a generally smaller amplitude than the desired signal, appearing at the negative of the frequency of the desired signal.

In general, the characteristics of the RSB may vary with various factors or parameters, such as the distance of the RSB from the LO frequency, the band utilized for communication, the gain state, and the temperature of the mixer.

An RSB is broadly an undesirable aspect of a mixer. For example, the existence of the RSB may result in an increase in bit errors in a wireless communication system.

RSB calibration is employed to reduce the I/Q imbalance of the mismatched mixer. RSB calibration based on input I and Q signals is well known in the art.

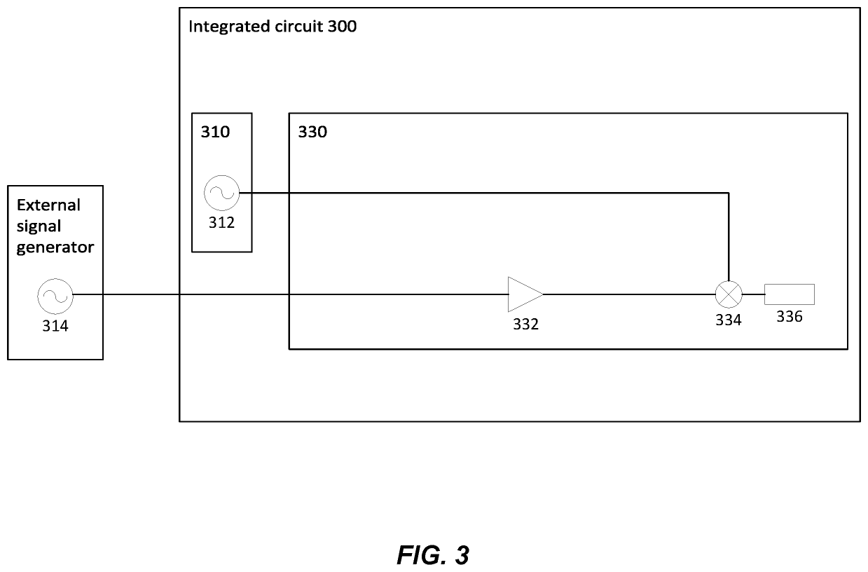

FIG. 3 shows an example for an integrated circuit 300 used in RSB calibration. In particular, the IC 300 in FIG. 3 uses an external signal generator 314 to provide a RF input calibration tone signal via a driver or low noise amplifier 332 to a mixer 334. In this context “external” means that the signal generator 314 is not implemented on the same integrated circuit 300 as the receiver/transmitter path 330 to be calibrated. The mixer 334 further receives a local oscillator signal from the oscillator 312. The signals output by the mixer 334 are provided to an RSB calibration unit 336. While the use of such an external signal generator 314 reduces the generation of spur signals (or distortion signals) due to the existing distance and isolation from the IC 300 on which the receiver/transmitter path 330 is arranged, external hardware is necessary which requires additional space and costs. Furthermore, it is challenging to calibrate multiple receiver/transmitter paths simultaneously with the use of an external signal generator 314. It is noted that any reference to “RF” in this description also includes the use of intermediate frequency (IF). For example, the RF input calibration tone signal may also be an IF input calibration tone signal.

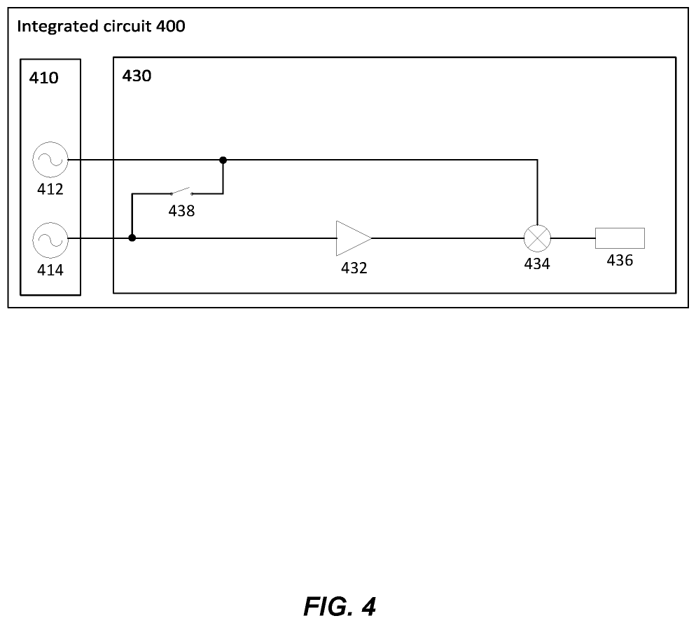

FIG. 4 shows another example for an integrated circuit 400 used in RSB calibration. In particular, the IC 400 in FIG. 4 has implemented therein low power mode (LPM) phase locked loops (PLLs) 414 and high power mode (HPM) phase locked loops (PLLs) 412 co-located within the same oscillator system 410 on the IC 400. When not in an RSB calibration mode, HPM PLL 412 and LPM PLL 414 are used for providing local oscillator signals for mixer 434 in a respective high power mode and low power mode, wherein, when in low power mode, the switch 438 is enabled and, when in high power mode, the switch 438 is disabled. In the RSB calibration mode, the switch 438 may be disabled (i.e. in an off-state). In the RSB calibration mode, the HPM PLL 412 is used to generate and provide a local oscillator signal to the mixer 434. The LPM PLL 414 is used to generate and provides another oscillator signal to the tone generator 432 which generates and provides a RF input calibration tone signal to the mixer 434. The mixer 434 mixes (or downconverts) the local oscillator signal with the RF input calibration tone signal and forwards the mixed signal (i.e. the downconverted RF input calibration tone signal) to the RSB calibration unit 436 of the receiver/transmitter path 430. While such an approach avoids using an external signal generator as in FIG. 3, two different frequency signals are generated close together and simultaneously within the same oscillator system. Generating two different frequency signals simultaneously and close together in the same oscillator system may generate spur tones. These spur tones may have baseband image tones degrading the RSB calibration accuracy.

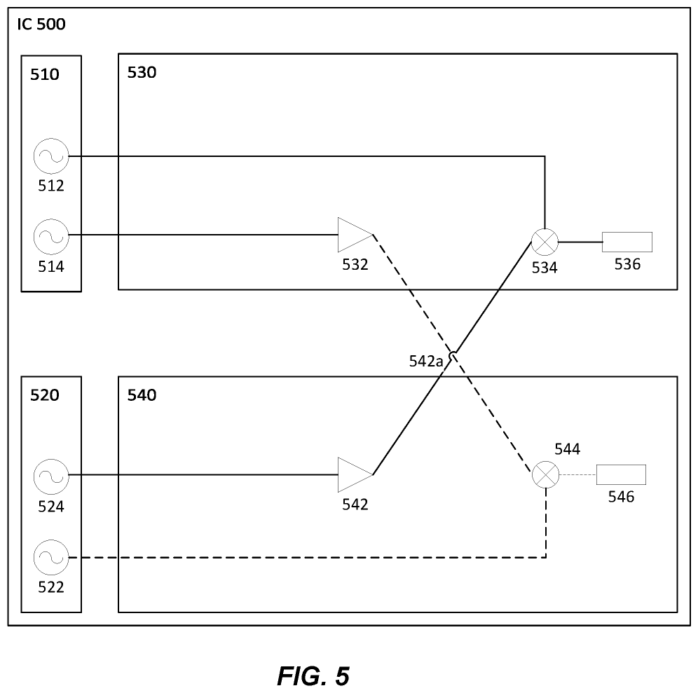

FIG. 5 shows an integrated circuit (IC) 500 in accordance with a first aspect. The IC is shown in a RSB calibration state. Other configurations of an RSB calibration state may also be implemented, as described below. In the RSB calibration state illustrated in FIG. 5, IC 500 does not process radio frequency (RF) signals which are received or transmitted via an antenna (not shown). Instead, an RF input calibration tone is generated and mixed with a local oscillator signal for RSB calibration purposes as further described below. The IC 500 can be implemented in a section of a transceiver, for example in a receiver chain or a transmitter chain as depicted in FIGS. 2A and 2B. The below description relates to the receiver chain. However, a skilled person will understand that the below described circuitry can also be implemented in the transmitter chain.

The IC 500 comprises a first oscillator system 510 and a second oscillator system 520 (for example, implemented in PLLs 282 and 292 above). The first oscillator system 510 and the second oscillator system can be implemented in the IC 500 in a respective location separated by a certain distance. They are coupled to respective downlink pipes (DLPs). The invention is not limited to two oscillator systems. Any number of oscillator systems is possible and covered by the invention. The first oscillator system 510 comprises a first oscillator 512 and a second oscillator 514. The first oscillator 512 generates at its output a first oscillating signal. The second oscillator 514 generates at its output a second oscillating signal. The frequency of the first oscillating signal can be different to the frequency of the second oscillating signal. The first oscillator 512 can be a high power mode (HPM) phase lock loop (PLL) and the second oscillator 514 can be a low power mode (LPM) PLL. The first oscillator 512 may also be any oscillator which can provide an oscillating signal sufficient for a transceiver operating in a high power mode with respect to performance, accuracy or efficiency. In the same manner, the second oscillator 514 may be any oscillator which can provide an oscillating signal sufficient for a transceiver operating in a low power mode with respect to performance, accuracy or efficiency. In some examples, the first oscillator 512 may be used for a mode characterized by a quality other than high power or the mode may be characterized by both a relatively higher power and one or more other qualities. Similarly, the second oscillator 514 may be used for a mode characterized by a quality other than low power or the mode may be characterized by both a relatively lower power and one or more other qualities, which may be the same or different than the qualities of the first oscillator 512 mode. For example, the first oscillator 512 may be a high data rate mode PLL, while the second oscillator 514 may be a low data rate PLL. In some such configurations, the high power mode PLL may meet higher or stricter performance requirements than the low power mode PLL. While descriptions below may use the terms HPM and/or LPM, such descriptions can be applied equally to PLLs having other modes.

The second oscillator system 520 also comprises a first oscillator 522 and a second oscillator 524. The first oscillator 522 generates a first oscillating signal. The second oscillator 524 generates a second oscillating signal. The frequency of the first oscillating signal can be different to the frequency of the second oscillating signal. The first and second oscillator of the second oscillator system 520 can be different or can be configured similar to the first and second oscillator of the first oscillator system 510. For example, in a mission mode, the first oscillator system 510 provides a LO signal for a first signal path 530, the second oscillator system 520 provides a LO signal for the second signal path 540. If signal paths 530 and 540 are associated with different band signals, there may be no frequency relationship between the first oscillator system 510 and the second oscillator system 520. If signal paths 530 and 540 are in carrier aggregation (CA) mode, the LO frequency difference provided by oscillator systems 510 and 520 may be fixed and follow CA operation requirement, e.g. 100 MHz or 200 MHz. In the RSB calibration mode, the frequency difference provided by oscillator systems 510 and 520 may be fixed and follow an RSB calibration target offset frequency, e.g., 20 MHz, 40 MHz, or 80 MHz. The first oscillator 522 can be a high power mode (HPM) phase lock loop (PLL) and the second oscillator 524 can be a low power mode (LPM) PLL, and/or the first oscillator 522 can be a high data rate or performance mode PLL and the second oscillator may be a low data rate or performance mode PLL. The first oscillator 522 may also be any oscillator which can provide an oscillating signal sufficient for a transceiver operating in a high power mode with respect to performance, accuracy or efficiency. In the same manner, the second oscillator 524 may be any oscillator which can provide an oscillating signal sufficient for a transceiver operating in a low power mode with respect to performance, accuracy or efficiency.

The HPM (or high data rate or performance) PLLs may each comprise an inductance capacitance voltage controlled oscillator (LC VCO) coupled in a PLL. The LPM (or high data rate or performance) PLLs may each comprise a ring voltage controlled oscillator (VCO) coupled in another PLL.

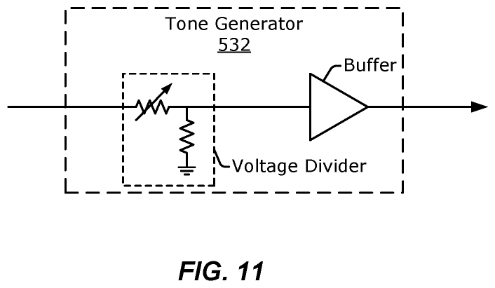

The first oscillator system 510 is coupled to a first signal path 530, referred to in the present example as a receiver chain or DLP. The second oscillator system 520 is coupled to a second signal path 540, also referred to in the present example as a receiver chain DLP. While only two receiver chains are shown, any number of receiver chains is covered by the invention. The first receiver chain 530 includes a first tone generator 532 (for example implemented in signal generators 280 and 290) and a first I/Q mixer 534 (for example implemented in mixers 261a and 261b in the downconverter 260 or in mixers 241a and 241b in the upconverter 240). An input of the first tone generator 532 is coupled to the output of the second oscillator 514 of the first oscillating system 510. The first tone generator 532 is configured to receive at its input the second oscillating signal of the second oscillator 514 and configured to generate a first RF input calibration tone at its output. The second receiver chain 540 includes a second tone generator 542 and a second I/Q mixer 544. An input of the second tone generator 542 is coupled to the output of the second oscillator 524 of the second oscillating system 520. The second tone generator 542 is configured to receive at its input the second oscillating signal of the second oscillator 524 and configured to generate at its output a second RF input calibration tone. The first and second tone generator 532 and 542 may be a tone generator as depicted in FIG. 11. The tone generator in FIG. 11 is composed by two cascaded parts: the first part is a voltage divider to attenuate the signal from, for example, oscillator 514 to mimic an LNA input signal; the second part is a buffer which may be a copy of an LNA (e.g., an LNA configured to provide a data signal in a mission mode). The advantage of using the described LPM PLLs for generating the input signal to the tone generator (e.g. tone generator 532, 542) is to reduce EM coupling between two high power mode PLLs (e.g. HPM PLLs 512, 522), for example by reducing the coupling between inductors in the high power mode PLLs. In addition, power in calibration mode can be saved with a low power PLL, thereby increasing efficiency.

Further referring to FIG. 5, an input of the first I/Q mixer 534 is coupled to the output of the second tone generator 542 and configured to receive at its inputs the first oscillating signal from the first oscillator 512 and the second RF input calibration tone from the second tone generator 542. The first I/Q mixer 534 is further configured to generate at its output a mixed signal at baseband. The mixed signal is then forwarded to an RSB calibration unit 536, which may or may not be implemented on the IC 500. For example, the calibration unit 536 may be implemented in the data processor 210, e.g., in the processor 296.

By using the second oscillator 524 of the second oscillator system 520 and the second tone generator 542 of the second receiver chain 540 for generating the RF input calibration tone for the RSB calibration of the first receiver chain 530, the source of spur signals is greatly reduced. This may be due to reduced VDD/GND network coupling because of the separated packages or areas in which the tone generator 542 and local oscillator 512 are arranged. This may be due to reduced electromagnetic coupling between the routing for the local oscillator signal from local oscillator 512 and the routing for the RF input calibration tone from tone generator 542. Moreover, this may be due to reduced electromagnetic coupling because of the separated oscillators 512 and 524 generating signals in separated oscillator systems.

The skilled person will understand that, in this example, second oscillator 514, first tone generator 532, second I/Q mixer 544, and first oscillator 522 are not used in the RSB calibration of the first receiver chain 530 and thus are optional for the RSB calibration of the first receiver chain 530. However, the skilled person will also understand that second oscillator 514, first tone generator 532, second I/Q mixer 544, and first oscillator 522 are required in a RSB calibration of the second receiver chain 540 corresponding to the RSB calibration of the first receiver chain 530 in the example described above. For example, in the RSB calibration of the second receiver chain 540, an input of the second I/Q mixer 544 is coupled to the output of the first tone generator 532 and configured to receive at its inputs the first oscillating signal from the first oscillator 522 and the first RF input calibration tone from the first tone generator 532. The second I/Q mixer 544 is further configured to generate at its output a mixed signal at baseband. The mixed signal is then forwarded to an RSB calibration unit 546 used for calibrating the second receiver chain 540. The RSB calibration unit 546 may or may not be implemented on the IC 500. For example, the calibration unit 546 may be implemented in the data processor 210, e.g., in the processor 296.

The coupling between the second tone generator 542 and the first I/Q mixer 534 may be implemented by using a metal trace 542a or by using a switch or switch matrix (not shown). The switch matrix is also implemented in the IC 500 and coupled to any receiver chain of a plurality of receiver chains in the system. Using a switch matrix provides increased flexibility. For example, a switch matrix can provide an easy way to change the routing of the RF input calibration tone signal of the tone generator 542 to the various receiver/transmitter chains (for example, when there are more than two receiver chains in the transceiver section). Also, a single one of the receiver chains can be chosen to act as the only element to provide the RF input calibration tone signal to all or a subset of the remaining receiver/transmitter chains in the system. Further, when there are more than two chains, the chains may be paired such that each chain in the pair is used to calibrate the other chain in the pair. As another example, when there are more than two chains, each chain may be used to calibrate a respective other chain, such as in a loop or daisy chain configuration.

When not in calibration mode, e.g., when in a mode where the receiver chains are used for receiving data (i.e. in a so-called mission mode (not shown)), the interconnection of the circuit elements is different. For example, regarding receiver chain 530, the I/Q mixer 534 is coupled to a data signal received, for example, by antenna(s) 248 and forwarded by LNA 252 and filter 254, and the I/Q mixer 534 may also be coupled to the first oscillator 512 in this mission mode. The output of the I/Q mixer 534 is then provided to ADCs 216a and 216b via amplifiers 262a, 262b and baseband filters 264a and 264b. The ADCs 216a and 216b perform analog-to-digital conversion of the received data signal in order to provide digital data which can be processed by the processor 296. The skilled person will understand that such interconnection also applies to receiver chain 540 when the receiver chain 540 is also in a mission mode. A mode switch (not shown) may be implemented to switch between the calibration mode and the mission mode.

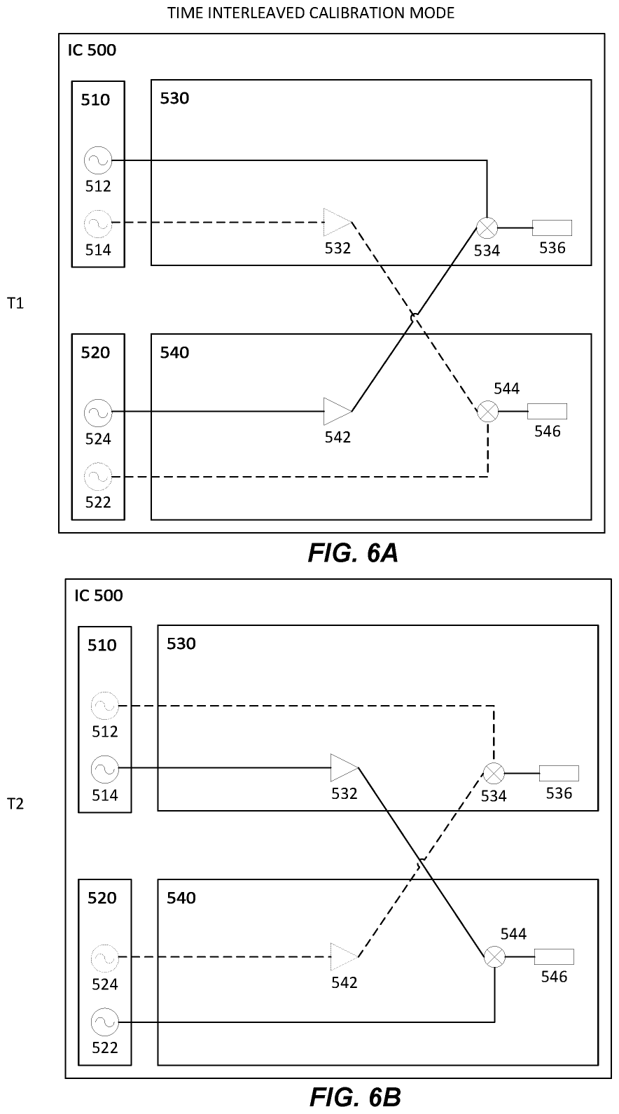

FIG. 6A and FIG. 6B show a second aspect. Each of FIGS. 6A and 6B correspond to FIG. 5 with the following differences. In particular, each of FIGS. 6A and 6B show the IC 500 configured in respective RSB calibration states in a time interleaved calibration mode in which the first receiver chain 530 is calibrated at time T1 (FIG. 6A) and the second receiver chain 540 is calibrated at time T2 (FIG. 6B). Time T2 is after or before time T1. At T1, second oscillator 514, tone generator 532 are disabled within the combination of the first oscillator system 510 and the first receiver chain 530. Furthermore, at T1, the first oscillator 522 is disabled within the second oscillator system 520.

At T2, the second oscillator 524 and the tone generator 542 are disabled within the combination of the second oscillator system 520 and the second receiver chain 540. Furthermore, at T2, the first oscillator 512 is disabled within the first oscillator system 510. Disabled elements in FIGS. 6A and 6B are shown using dashed lines.

Disabling/enabling of elements within the oscillator systems and the receiver chains can be performed by a mode controller (for example, implemented in the processor 296). Such a mode controller may be implemented within a digital signal processor or any other processor coupled to the integrated circuit 500. The mode controller is further detailed below.

Disabling the second oscillator 514, the tone generator 532 and the first oscillator 522 at time T1 when calibrating the receiver chain 530 provides the advantage that reduced or no distortion is caused by the disabled elements. As a result, spur tones which are normally generated by enabled second oscillator 514, tone generator 532 and first oscillator 522 are completely avoided in some configurations. Moreover, inasmuch as oscillators 512 and 524 are separated from each other to a larger extent than for example oscillator 512 from 514 (which reside on the same oscillating system package or in the same area), electromagnetic (EM) coupling between oscillators 512 and 524 is reduced. Also, any passive EM coupling of the routing between the I/Q mixer 534 and the oscillator 512 and the routing between the I/Q mixer 534 and the oscillator 524 is decreased because of the increased distance between those two routings, especially when compared to the routing of the circuit in FIG. 4.

The above is particularly true when, for example, the switch 438 of FIG. 4 is part of controlling switching between a low power mode and a high power mode when no RSB calibration takes place. If the switch 438 is implemented, and even if the switch 438 is set to off (disabled) during RSB calibration, the switch 438 is still coupled to the second oscillator 514 generating and providing an oscillating signal to the switch 438. As a result, spur tones may be generated and coupled into the I/Q mixer 534 because of limited isolation between the switch 438 and the input of the mixer 434. The present invention avoids this situation because the second oscillator 514 can be disabled and no signal is provided to the switch 438 which could cause the generation of spur tones.

The same advantages as above can be achieved at time T2 where first oscillator 512, the second oscillator 524 and the second tone generator 542 are disabled when the receiver chain 540 is calibrated. Therefore, calibrating receiver chains 530 and 540 one after the other using the above configuration of disabled/enabled elements in a so called time interleaved calibration mode has the advantage of reduced spur tones because of reduced conductive and EM coupling. Accordingly, improved RSB calibration can be achieved.

While FIGS. 6A and 6B illustrate two receiver chains, the time interleaved calibration mode is not limited in this respect. For example, more than two receiver chains can be used and time interleaved calibration will be performed for each receiver chain at a specific different time. A mode controller can control the time and also which receiver chain provides the tone signal for calibrating the other receiver chain. Also, a particular receiver chain can be controlled by the mode controller to provide the tone signal for calibrating all the other receiver chains at their distinct calibration time.

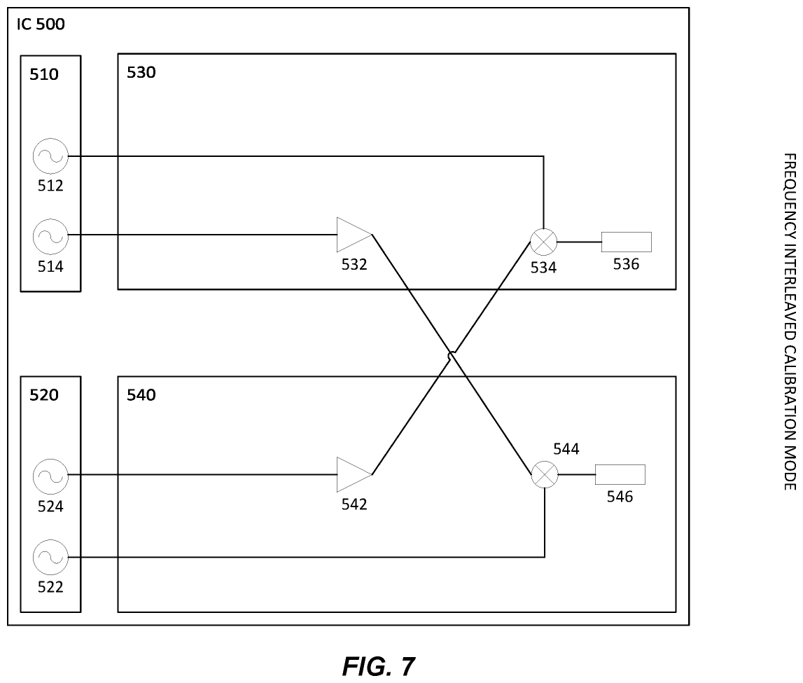

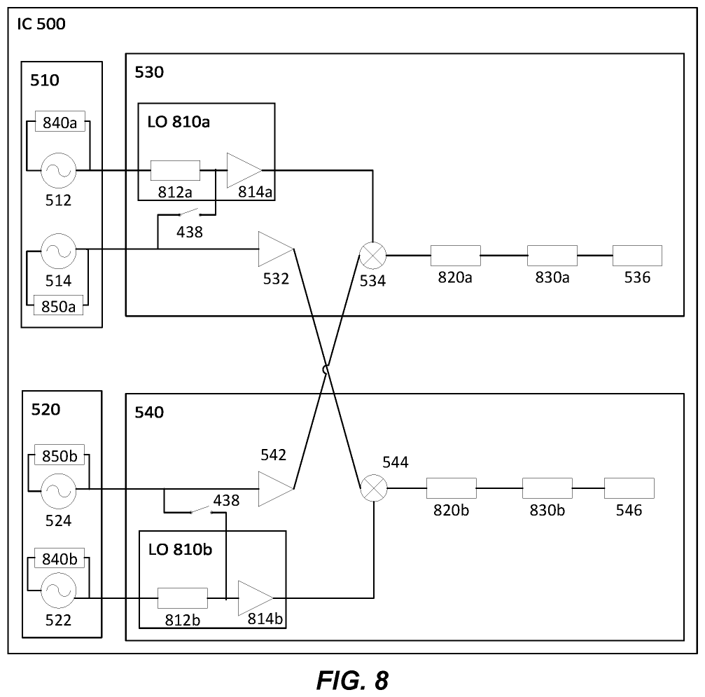

FIG. 7 shows a third aspect. FIG. 7 corresponds to FIG. 5 with the difference that both receiver chains 530 and 540 are calibrated at the same time in parallel, and may correspond to an RSB calibration state. Therefore, the coupling between the first tone generator 532 and the second mixer 544 as well as the coupling between the first oscillator 522 and the second mixer 544 are active and used when performing RSB calibration of the first and second receiver chain 530 and 540. Such a mode is called a frequency interleaved calibration mode herein. In the frequency interleaved calibration mode a plurality of receiver chains can be calibrated simultaneously. Calibrating a plurality of receiver chains simultaneously reduces the time necessary for overall calibration in comparison to the scenario when only one receiver chain at a time is calibrated.

The first and the second receiver chain 530 and 540 can be configured to process signals in different frequency bands. As such, RSB calibration can also be performed in different frequency bands for each receiver chain. In order to reduce spur tones affecting the simultaneous RSB calibration in both receiver chains 530 and 540, receiver chain 530 can be configured to a frequency band different to the frequency band of the receiver chain 540. When the frequency bands are selected appropriately, any spur tones or image tones generated by the elements (i.e. oscillator 512, oscillator 524 and second tone generator 542) used for generating signals for the I/Q mixer 534 of the first receiver chain 530 will not significantly negatively affect (or fall on a frequency of) signals generated for and provided to the I/Q mixer 544 by the first oscillator 522, the second oscillator 514 and the first tone generator 532. The selection of the frequency bands and the setting of the oscillators 512, 514, 522, 524 to appropriate frequencies may be performed by a mode controller (for example, implemented in the processor 296), which may be same as the mode controller described above or implemented separately from the mode controller described above.

Further, the type of mode which is used for the RSB calibration can be controlled by a mode controller (for example, implemented in the processor 296), which may be the same as the mode controller described above or implemented separately therefrom. For example, the mode controller may be coupled to the first and second oscillator system 510 and 520 as well as the first and second receiver chains 530 and 540. The mode controller may control the oscillating frequency of the respective oscillators 512, 514, 522, and 524, and whether oscillators 512, 514, 522, and 524 are disabled or enabled. The mode controller may further control first and second tone generator 532 and 534. For example, the mode controller may disable or enable first and second tone generator 532 and 542. For example, the mode controller may set a mode of the RSB calibration to a time interleaved calibration mode or a frequency interleaved calibration mode.

In the time interleaved calibration mode, the mode controller disables the second oscillator 514, the first tone generator 532 and the first oscillator 522 at time T1 and the RSB calibration is performed for the first receiver chain 530 in accordance with the above description in relation to FIG. 6A (at T1). At time T2, i.e. after or before time T1, the mode controller disables the second oscillator 524, the second tone generator 542, and the first oscillator 512 and the RSB calibration is performed for the second receiver chain 540 in accordance with the above description in relation to FIG. 6B (at T2).

In the frequency interleaved calibration mode, the mode controller enables all oscillators 512, 514, 522 and 524 and tone generators 532 and 542 and controls the oscillating signals of the respective oscillators so that the RSB calibration of the receiver chain 530 is performed on a different frequency band than the RSB calibration of the second receiver chain 540. As stated above, when in frequency interleaved calibration mode, RSB calibration is performed simultaneously for first receiver chain 530 and second receiver chain 540.

Using a mode controller to set the RSB calibration to a time interleaved calibration mode or to a frequency interleaved calibration mode provides increased flexibility for the RSB calibration. While the RSB calibration in the time interleaved calibration mode may be degraded less because of reduced spur tones and/or have fewer constraints with respect to calibration frequencies used, the time of RSB calibration may be faster in the frequency interleaved calibration mode over all receiver chains in the system. While the mode controller is described above as setting the RSB calibration to a time interleaved calibration mode or to a frequency interleaved calibration mode, a device including the IC 500 may be configured to implement only one of a time interleaved calibration mode and a frequency interleaved calibration mode and mode controllers described herein may therefore omit functionality of setting the mode.

While FIG. 7 illustrate two receiver chains, the frequency interleaved calibration mode is not limited in this respect. For example, more than two receiver chains can be used and frequency interleaved calibration will be performed for each receiver chain concurrently. A mode controller can control which receiver chain provides the tone signal for calibrating another receiver chain. Also, a particular receiver chain can be selected and controlled by the mode controller to provide the tone signal for concurrently calibrating some or all of the remaining receiver chains.

FIG. 8 shows a more detailed implementation in relation to further structural elements which may be used for generating signals for RSB calibration. FIG. 8 corresponds to the structure illustrated in FIGS. 5-7 except that local oscillators 810a and 810b, baseband filters 820a and 820b (for example baseband filters 264a and 264b of FIGS. 2A/2B) and analog-to-digital converters 830a and 830b (for example, ADCs 216a and 216b of FIGS. 2A/2B) are added into the respective receiver chains 530 and 540. For the first receiver chain 530, local oscillator 810a includes a divider 812a and a driver 814a (which can be implemented in signal generator 280/290 of FIGS. 2A/2B) having an input connected to an output of the divider 812a. An input of divider 812a is coupled to the output of first oscillator 512 and the divider 812a is configured to divide the frequency of the first oscillating signal by an integer value. Driver 814a is configured to pass on the divided first oscillating signal to mixer 534. The mixer 534 mixes the RF input calibration tone signal from the oscillator 524 and tone generator 542 with the divided first oscillating signal to convert the RF input calibration tone signal to a baseband frequency (i.e., downconvert). The baseband signals output by the mixer 534 may be filtered by the baseband filter 820a before being converted by the analog-to-digital converter 830a to digital I and Q signals. The digital I and Q signals are then forwarded to the RSB calibration unit 536 for the RSB calibration process. The HPM PLLs (as described above) may each comprise an inductance capacitance voltage controlled oscillator (LC VCO: illustrated as the component above the labels 512 and 522) coupled to other components 840a (e.g., a phase comparator, a loop filter, etc.) of the PLL. The LPM PLLs (as described above) may each comprise a ring voltage controlled oscillator (VCO: illustrated as the component above the labels 514 and 524) coupled to other components 850a (e.g., a phase comparator, a loop filter, etc.) of the PLL. Second receiver chain 540 shows corresponding elements 810b, 820b, 830b, 840b, and 850b. Also, the above description similarly applies to the second receiver chain 540, whereas the function of elements 810b, 820b, 830b, 840b, and 850b is similar to respective elements 810a, 820a, 830a, 840a, and 850a but may vary in terms of their implementation or settings.

As an alternative to the above, RSB calibration may also be performed when the switch 438 is enabled (i.e. in an ON-state). This is referred to as a low power mode local oscillator RSB calibration (i.e. LPM LO RSB calibration). In that case, tone generator 532 as well as some (e.g. oscillator 512) or all HPM PLLs may be disabled (or shut off) to avoid affecting the signal from the second oscillator 514. As such, the signal from the second oscillator 514 is buffered by buffer 814a so that the mixer 534 generates a mixed signal at baseband based on the buffered signal and the RF input calibration tone generated by the tone generator 542.

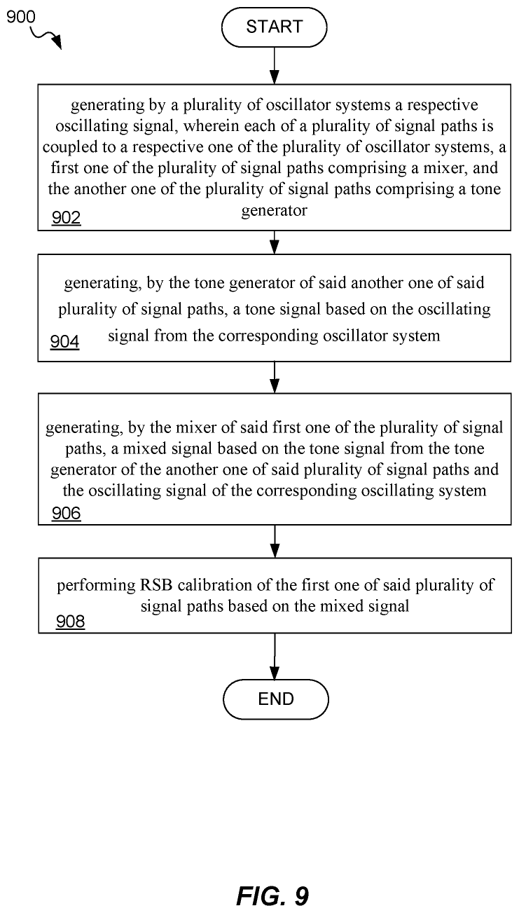

FIG. 9 is a flow chart describing an example of the operation of a method 900 for RSB calibration in accordance with a fourth aspect. The method may be performed by the IC of any one of FIGS. 5 to 8 and the description thereof as provided above.

In block 902, a respective oscillating signal is generated by a plurality of oscillator systems, wherein each of a plurality of signal paths is coupled to a respective one of the plurality of oscillator systems. A first one of the plurality of signal paths comprises a mixer, and another one of the plurality of signal paths comprises a tone generator.

In block 904, a tone signal is generated by the tone generator of said another one of said plurality of signal paths based on the oscillating signal from the corresponding oscillator system.

In block 906, a mixed signal is generating by the mixer of said first one of the plurality of signal paths based on the tone signal from the tone generator of the another one of said plurality of signal paths and based on the oscillating signal of the corresponding oscillating system.

In block 908, RSB calibration of the first one of said plurality of signal paths is performed based on the mixed signal.

The method may also comprise switching, by a mode controller, the plurality of signal paths to a frequency interleaved calibration mode or to a time interleaved calibration mode, wherein in the frequency interleaved calibration mode, the method further comprises calibrating the first one and the another one of the plurality of signal paths in parallel, and wherein, in the time interleaved calibration mode, the method further comprises calibrating the first one and the another one of the plurality of signal paths one after the other.

In the time interleaved calibration mode, the method may further disable the second oscillator of the oscillator system coupled to the first one of said plurality of signal paths, the tone generator of the first one of said plurality of signal paths, and the first oscillator of the another one of said plurality of signal paths.

In the frequency interleaved calibration mode, the mixer of said another one of said plurality of signal paths may be coupled to the TG of said first one of said plurality of signal paths. If coupled, the mixer may receive the tone signal from the TG of said first one of the plurality of signal paths, receive the first oscillating signal from the first oscillator of the oscillator system coupled to said another one of said plurality of signal paths, and generate another mixed signal based on the received tone signal and the received first oscillating signal.

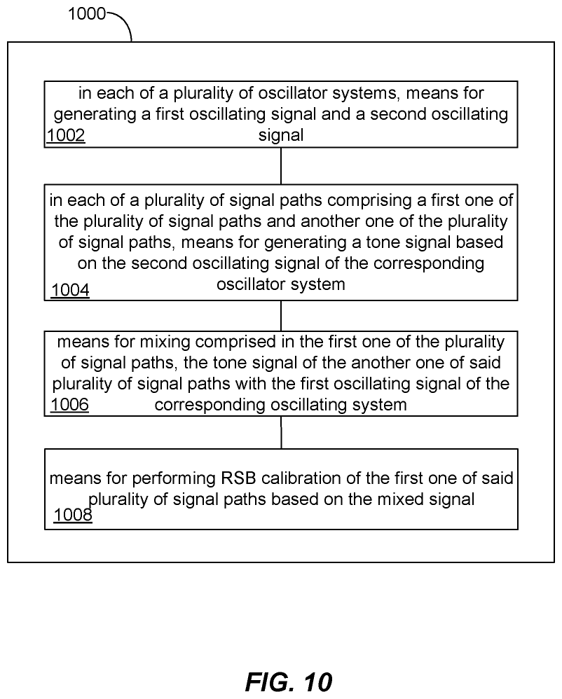

FIG. 10 is a functional block diagram of an apparatus 1000 in accordance with a fifth aspect.

The apparatus 1000 comprises in each of a plurality of oscillator systems, means 1002 for generating a first oscillating signal and a second oscillating signal. The apparatus 1000 further comprises, in each of a plurality of transmission paths comprising a first one of the plurality of signal paths and another one of the plurality of signal paths, means 1004 for generating a tone signal based on the second oscillating signal of the corresponding oscillator system. In the apparatus 1000, each of the plurality of signal paths is coupled to a respective one of the plurality of the oscillator systems. Means 1006 for mixing are also comprised in the first one of the plurality of signal paths of the apparatus 1000, wherein the means 1006 for mixing are configured to mix the tone signal of the another one of said plurality of signal paths with the first oscillating signal of the corresponding oscillating system. Furthermore, the apparatus 1000 comprises means 1008 for performing RSB calibration of the first one of said plurality of signal paths based on the mixed signal.

The apparatus 1000 may further comprise means for switching the plurality of signal paths to a frequency interleaved calibration mode or to a time interleaved calibration mode. In the frequency interleaved calibration mode, the apparatus 1000 may further comprise means for calibrating the first one and the another one of the plurality of signal paths in parallel. In the time interleaved calibration mode, the means for calibrating may be configured to calibrate the first one and the another one of the plurality of signal paths one after the other.

In the time interleaved calibration mode, the means for switching may be configured to disable the generation of the second oscillating signal of the oscillator system coupled to the first one of said plurality of signal paths, the means for generating the tone signal of the first one of said plurality of signal paths, and the generation of the first oscillating signal of the another one of said plurality of signal paths.

In the frequency interleaved calibration mode, the means 1006 for mixing of said another one of said plurality of signal paths may be configured to receive the tone signal from the means for generating a tone signal of said first one of the plurality of signal paths, receive the first oscillating signal from the oscillator system coupled to said another one of said plurality of signal paths, and generate another mixed signal based on the received tone signal and the received first oscillating signal.

Implementation examples are described in the following numbered clauses:
Clause 1. An integrated circuit (IC), comprising:
   a plurality of oscillator systems each configured to generate a respective oscillating signal;
   a plurality of signal paths each coupled to a respective one of the plurality of oscillator systems;
   a first one of the plurality of signal paths comprising a mixer,
   another one of the plurality of signal paths comprising a tone generator;
   the tone generator of the another one of said plurality of signal paths configured to generate a tone signal based on the oscillating signal from the corresponding oscillator system;
   the mixer of said first one of said plurality of signal paths coupled to the tone generator of said another one of said plurality of signal paths and configured to generate a mixed signal for RSB calibration based on the tone signal from the tone generator of said another one of the plurality of signal paths and the oscillating signal from the oscillator system coupled to said first one of said plurality of signal paths.
Clause 2. The IC of clause 1, wherein the plurality of oscillator systems each comprise a first oscillator and a second oscillator, the first and second oscillator configured to provide a respective first and second oscillating signal, wherein the oscillating signal based on which the mixed signal is generated is the first oscillating signal from the first oscillator of the oscillator system coupled to said first one of said plurality of signal paths, and wherein the oscillating signal based on which the tone signal is generated is the second oscillating signal from the second oscillator of the oscillator system corresponding to the another one of the plurality of signal paths.
Clause 3. The IC of anyone of clauses 1 and 2, wherein each of the plurality of signal paths comprises a tone generator and a mixer, wherein the tone generator of the first one of said plurality of signal paths and of the another one of said plurality of signal paths each is configured to generate a tone signal based on the respective second oscillating signal from the second oscillator of the corresponding oscillator system.
Clause 4. The IC of anyone of clauses 1 to 3, wherein the first oscillator is a high power mode phase lock loop (HPM PLL), and the second oscillator is a low power mode phase lock loop (LPM PLL).
Clause 5. The IC of clause 4, wherein the LPM PLL comprises a ring voltage controlled oscillator (VCO) coupled in a first PLL.
Clause 6. The IC of clause 4, wherein the HPM PLL comprises an inductance capacitance voltage controlled oscillator (LC VCO) coupled in a second PLL.
Clause 7. The IC of anyone of clauses 1 to 3, wherein the first one of the plurality of signal paths is arranged adjacent to the another one of the plurality of signal paths on the IC.
Clause 8. The IC of anyone of clauses 1 to 3, wherein each of the plurality of signal paths further comprises:
   a baseband filter coupled to an output of the mixer, the baseband filter configured to generate a baseband filtered signal;
   an analog-to-digital converter (ADC) coupled to an output of the ADC and configured to generate a digital inphase (I) signal and a digital quadrature-phase (Q) signal from the baseband filtered signal.
Clause 9. The IC of clause 8, wherein the I and Q signals are provided to a residual sideband (RSB) calibration unit for residual sideband calibration.
Clause 10. The IC of anyone of clauses 3 to 9, wherein the first oscillating signal is different in frequency than the second oscillating signal.
Clause 11. The IC of anyone of clauses 3 to 9, wherein each of the plurality of signal paths further comprises a local oscillator comprising a divider and a driver, wherein the divider is configured to generate a divided signal based on the first oscillating signal, and wherein the driver is configured to output the divided signal to the mixer.
Clause 12. The IC of anyone of clauses 1 to 11, wherein each of the plurality of signal paths further comprises a switch coupled between an output of the second oscillator and an input of the driver.
Clause 13. The IC of anyone of clauses 3 to 12, wherein the mixer of said another one of said plurality of signal paths is coupled to the tone generator of said first one of said plurality of signal paths and configured to generate another mixed signal based on the tone signal from the tone generator of said first one of the plurality of signal paths and the first oscillating signal from the first oscillator of the oscillator system coupled to said another one of said plurality of signal paths.
Clause 14. The IC of clause 3 further comprising a mode controller configured to switch the plurality of signal paths to a frequency interleaved calibration mode or to a time interleaved calibration mode, wherein in the frequency interleaved calibration mode the first one and the another one of the plurality of signal paths are calibrated in parallel, and wherein in the time interleaved calibration mode the first one and the another one of the plurality of signal paths are calibrated one after the other.
Clause 15. The IC of clause 14, wherein, in the time interleaved calibration mode, the second oscillator of the oscillator system coupled to the first one of said plurality of signal paths, the tone generator of the first one of said plurality of signal paths, and the first oscillator of the another one of said plurality of signal paths are disabled.
Clause 16. The IC of clause 14, wherein, in the frequency interleaved calibration mode, the mixer of said another one of said plurality of signal paths is coupled to the tone generator of said first one of said plurality of signal paths and configured to generate another mixed signal based on the tone signal from the tone generator of said first one of the plurality of signal paths and the first oscillating signal from the first oscillator of the oscillator system coupled to said another one of said plurality of signal paths.
Clause 17. The IC of anyone of clauses 14 to 16, wherein, in the frequency interleaved calibration mode, the oscillator system of the first one of the plurality of signal paths is configured for providing oscillating signals in a frequency band different to a frequency band the oscillator system of the another one of the plurality of signal paths is configured to.
Clause 18. The IC of anyone of clauses 1 to 3, wherein the mixer is an in-phase (I)/quadrature-phase (Q) mixer, wherein the mixed signal comprises an I/Q signal.
Clause 19. The IC of anyone of clauses 1 to 3, wherein the plurality of signal paths are coupled with each other in a daisy chain configuration or in a loop configuration such that each one of the plurality of signal paths is used to calibrate a respective other one of the plurality of signal paths.
Clause 20. A method for residual sideband (RSB) calibration, comprising:
   generating by a plurality of oscillator systems a respective oscillating signal, wherein each of a plurality of signal paths is coupled to a respective one of the plurality of oscillator systems, a first one of the plurality of signal paths comprising a mixer, and another one of the plurality of signal paths comprising a tone generator;
   generating, by the tone generator of said another one of said plurality of signal paths, a tone signal based on the oscillating signal from the corresponding oscillator system,
   generating, by the mixer of said first one of the plurality of signal paths, a mixed signal based on the tone signal from the tone generator of the another one of said plurality of signal paths and the oscillating signal of the corresponding oscillating system; and
   performing RSB calibration of the first one of said plurality of signal paths based on the mixed signal.
Clause 21. The method of clause 20, wherein the plurality of oscillator systems each comprise a first oscillator and a second oscillator, the first and second oscillator configured to provide a respective first and second oscillating signal, wherein the oscillating signal based on which the mixed signal is generated is the first oscillating signal from the first oscillator of the oscillator system coupled to said first one of said plurality of signal paths, and wherein the oscillating signal based on which the tone signal is generated the second oscillating signal from the second oscillator of the oscillator system corresponding to the another one of the plurality of signal paths.
Clause 22. The method of anyone of clauses 20 to 21, wherein each of the plurality of signal paths comprises a tone generator and a mixer, wherein the tone generator of the first one of said plurality of signal paths and of the another one of said plurality of signal paths each generates a tone signal based on the respective oscillating signal from the second oscillator of the corresponding oscillator system.
Clause 23. The method of anyone of clauses 20 to 22 further comprising switching, by a mode controller, the plurality of signal paths to a frequency interleaved calibration mode or to a time interleaved calibration mode, wherein in the frequency interleaved calibration mode, the method further comprises calibrating the first one and the another one of the plurality of signal paths in parallel, and wherein, in the time interleaved calibration mode, the method further comprises calibrating the first one and the another one of the plurality of signal paths one after the other.
Clause 24. The method of clause 23, wherein, in the time interleaved calibration mode, the method further comprises disabling the second oscillator of the oscillator system coupled to the first one of said plurality of signal paths, the tone generator of the first one of said plurality of signal paths, and the first oscillator of the another one of said plurality of signal paths.
Clause 25. The method of clause 23, wherein, in the frequency interleaved calibration mode, the mixer of said another one of said plurality of signal paths is coupled to the tone generator of said first one of said plurality of signal paths and performs generating another mixed signal based on the tone signal from the tone generator of said first one of the plurality of signal paths and the first oscillating signal from the first oscillator of the oscillator system coupled to said another one of said plurality of signal paths.
Clause 26. An apparatus, comprising:
   in each of a plurality of oscillator systems, means for generating a respective oscillating signal;
   in each of a plurality of signal paths comprising a first one of the plurality of signal paths and another one of the plurality of signal paths, means for generating a tone signal based on the oscillating signal of the corresponding oscillator system,
   wherein each of the plurality of signal paths is coupled to a respective one of the plurality of the oscillator systems;
   means for mixing comprised in the first one of the plurality of signal paths, the tone signal of the another one of said plurality of signal paths with the oscillating signal of the corresponding oscillating system to generate a mixed signal; and
   means for performing RSB calibration of the first one of said plurality of signal paths based on the mixed signal.
Clause 27. The apparatus of clause 26, wherein in each of the plurality of oscillator systems the means for generating are configured to generate a first oscillating signal and a second oscillating signal,
   wherein the oscillating signal based on which the mixed signal is generated is the first oscillating signal from the oscillator system coupled to said first one of said plurality of signal paths, and
   wherein the oscillating signal based on which the tone signal is generated is the second oscillating signal from the oscillator system corresponding to the another one of the plurality of signal paths.
Clause 28. The apparatus of anyone of clauses 26 to 27 further comprising means for switching the plurality of signal paths to a frequency interleaved calibration mode or to a time interleaved calibration mode, wherein in the frequency interleaved calibration mode, the apparatus further comprising means for calibrating the first one and the another one of the plurality of signal paths in parallel, and wherein, in the time interleaved calibration mode, the means for calibrating are configured to calibrate the first one and the another one of the plurality of signal paths one after the other.
Clause 29. The apparatus of clause 28, wherein, in the time interleaved calibration mode, the means for switching are configured to disable the generation of the second oscillating signal of the oscillator system coupled to the first one of said plurality of signal paths, the means for generating the tone signal of the first one of said plurality of signal paths, and the means for generating the first oscillating signal of the another one of said plurality of signal paths.
Clause 30. The apparatus of clause 28, wherein, in the frequency interleaved calibration mode, the means for mixing of said another one of said plurality of signal paths is configured to generate another mixed signal based on the tone signal from the means for generating a tone signal of said first one of the plurality of signal paths and the first oscillating signal from the oscillator system coupled to said another one of said plurality of signal paths.
Clause 31. An apparatus, comprising:
   a first signal path;
   a second signal path;
   a first oscillator configured for use with the first signal path in a first mode;
   a second oscillator configured for use with the second signal path in a second mode;
   a processor configured to cause the first oscillator and the second oscillator to be coupled to a mixer in the first signal path, the processor further configured to perform residual sideband (RSB) calibration based on an output of the mixer.
Clause 32. The apparatus of clause 31, further comprising a third oscillator configured for use with the first signal path in the second mode.
Clause 33. The apparatus of clause 32, further comprising a fourth oscillator configured for use with the second signal path in the first mode.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. An integrated circuit (IC), comprising:
a plurality of oscillator systems each configured to generate a respective oscillating signal;
a plurality of signal paths each coupled to a respective one of the plurality of oscillator systems;
a first one of the plurality of signal paths comprising a mixer,
another one of the plurality of signal paths comprising a tone generator;
the tone generator of the another one of said plurality of signal paths configured to generate a tone signal based on the oscillating signal from the corresponding oscillator system;
the mixer of said first one of said plurality of signal paths coupled to the tone generator of said another one of said plurality of signal paths and configured to generate a mixed signal for residual sideband (RSB) calibration based on the tone signal from the tone generator of said another one of the plurality of signal paths and the oscillating signal from the oscillator system coupled to said first one of said plurality of signal paths.

2. The IC of claim 1, wherein the plurality of oscillator systems each comprise a first oscillator and a second oscillator, the first and second oscillator configured to provide a respective first and second oscillating signal,
wherein the oscillating signal based on which the mixed signal is generated is the first oscillating signal from the first oscillator of the oscillator system coupled to said first one of said plurality of signal paths, and
wherein the oscillating signal based on which the tone signal is generated is the second oscillating signal from the second oscillator of the oscillator system corresponding to the another one of the plurality of signal paths.

3. The IC of claim 2, wherein each of the plurality of signal paths comprises a tone generator and a mixer, wherein the tone generator of the first one of said plurality of signal paths and of the another one of said plurality of signal paths each is configured to generate a tone signal based on the respective second oscillating signal from the second oscillator of the corresponding oscillator system.

4. The IC of claim 3, wherein the first oscillator is a high power mode phase lock loop (HPM PLL), and the second oscillator is a low power mode phase lock loop (LPM PLL).

5. The IC of claim 4, wherein the LPM PLL comprises a ring voltage controlled oscillator (VCO) coupled in a first PLL.

6. The IC of claim 4, wherein the HPM PLL comprises an inductance capacitance voltage controlled oscillator (LC VCO) coupled in a second PLL.

7. The IC of claim 3, wherein the first one of the plurality of signal paths is arranged adjacent to the another one of the plurality of signal paths on the IC.

8. The IC of claim 3, wherein each of the plurality of signal paths further comprises:
a baseband filter coupled to an output of the mixer, the baseband filter configured to generate a baseband filtered signal;
an analog-to-digital converter (ADC) coupled to an output of the baseband filter and configured to generate a digital inphase (I) signal and a digital quadrature-phase (Q) signal from the baseband filtered signal.

9. The IC of claim 8, wherein the I and Q signals are provided to a residual sideband (RSB) calibration unit for residual sideband calibration.

10. The IC of claim 3, wherein the first oscillating signal is different in frequency than the second oscillating signal.

11. The IC of claim 3, wherein each of the plurality of signal paths further comprises a local oscillator comprising a divider and a driver,
wherein the divider is configured to generate a divided signal based on the first oscillating signal, and wherein the driver is configured to output the divided signal to the mixer.

12. The IC of claim 11, wherein each of the plurality of signal paths further comprises a switch coupled between an output of the second oscillator and an input of the driver.

13. The IC of claim 3, wherein the mixer of said another one of said plurality of signal paths is coupled to the tone generator of said first one of said plurality of signal paths and configured to generate another mixed signal based on the tone signal from the tone generator of said first one of the plurality of signal paths and the first oscillating signal from the first oscillator of the oscillator system coupled to said another one of said plurality of signal paths.

14. The IC of claim 3 further comprising a mode controller configured to switch the plurality of signal paths to a frequency interleaved calibration mode or to a time interleaved calibration mode, wherein in the frequency interleaved calibration mode the first one and the another one of the plurality of signal paths are calibrated in parallel, and wherein in the time interleaved calibration mode the first one and the another one of the plurality of signal paths are calibrated one after the other.

15. The IC of claim 14, wherein, in the time interleaved calibration mode, the second oscillator of the oscillator system coupled to the first one of said plurality of signal paths, the tone generator of the first one of said plurality of signal paths, and the first oscillator of the another one of said plurality of signal paths are disabled.

16. The IC of claim 14, wherein, in the frequency interleaved calibration mode, the mixer of said another one of said plurality of signal paths is coupled to the tone generator of said first one of said plurality of signal paths and configured to generate another mixed signal based on the tone signal from the tone generator of said first one of the plurality of signal paths and the first oscillating signal from the first oscillator of the oscillator system coupled to said another one of said plurality of signal paths.

17. The IC of claim 16, wherein, in the frequency interleaved calibration mode, the oscillator system of the first one of the plurality of signal paths is configured for providing oscillating signals in a frequency band different to a frequency band the oscillator system of the another one of the plurality of signal paths is configured to.

18. The IC of claim 3, wherein the mixer is an in-phase (I)/quadrature-phase (Q) mixer, wherein the mixed signal comprises an I/Q signal.

19. The IC of claim 3, wherein the plurality of signal paths are coupled with each other in a daisy chain configuration or in a loop configuration such that each one of the plurality of signal paths is used to calibrate a respective other one of the plurality of signal paths.

20. A method for residual sideband (RSB) calibration, comprising:
generating by a plurality of oscillator systems a respective oscillating signal, wherein each of a plurality of signal paths is coupled to a respective one of the plurality of oscillator systems, a first one of the plurality of signal paths comprising a mixer, and another one of the plurality of signal paths comprising a tone generator;
generating, by the tone generator of said another one of said plurality of signal paths, a tone signal based on the oscillating signal from the corresponding oscillator system,
generating, by the mixer of said first one of the plurality of signal paths, a mixed signal based on the tone signal from the tone generator of the another one of said plurality of signal paths and the oscillating signal of the corresponding oscillator system; and
performing residual sideband (RSB) calibration of the first one of said plurality of signal paths based on the mixed signal.

21. The method of claim 20, wherein the plurality of oscillator systems each comprise a first oscillator and a second oscillator, the first and second oscillator configured to provide a respective first and second oscillating signal,
wherein the oscillating signal based on which the mixed signal is generated is the first oscillating signal from the first oscillator of the oscillator system coupled to said first one of said plurality of signal paths, and
wherein the oscillating signal based on which the tone signal is generated is the second oscillating signal from the second oscillator of the oscillator system corresponding to the another one of the plurality of signal paths.

22. The method of claim 21, wherein each of the plurality of signal paths comprises a tone generator and a mixer, wherein the tone generator of the first one of said plurality of signal paths and of the another one of said plurality of signal paths each generates a tone signal based on the respective oscillating signal from the second oscillator of the corresponding oscillator system.

23. The method of claim 22 further comprising switching, by a mode controller, the plurality of signal paths to a frequency interleaved calibration mode or to a time interleaved calibration mode, wherein in the frequency interleaved calibration mode, the method further comprises calibrating the first one and the another one of the plurality of signal paths in parallel, and wherein, in the time interleaved calibration mode, the method further comprises calibrating the first one and the another one of the plurality of signal paths one after the other.

24. The method of claim 23, wherein, in the time interleaved calibration mode, the method further comprises disabling the second oscillator of the oscillator system coupled to the first one of said plurality of signal paths, the tone generator of the first one of said plurality of signal paths, and the first oscillator of the another one of said plurality of signal paths.

25. The method of claim 23, wherein, in the frequency interleaved calibration mode, the mixer of said another one of said plurality of signal paths is coupled to the tone generator of said first one of said plurality of signal paths and performs generating another mixed signal based on the tone signal from the tone generator of said first one of the plurality of signal paths and the first oscillating signal from the first oscillator of the oscillator system coupled to said another one of said plurality of signal paths.

26. An apparatus, comprising:
in each of a plurality of oscillator systems, means for generating a respective oscillating signal;
a plurality of signal paths comprising a first one of the plurality of signal paths and another one of the plurality of signal paths, wherein each of the plurality of signal paths is coupled to a respective one of the plurality of the oscillator systems;
means for generating a tone signal comprised in the another of the plurality of signals paths, based on the oscillating signal of the corresponding oscillator system;
means for mixing comprised in the first one of the plurality of signal paths, the tone signal of the another one of said plurality of signal paths with the oscillating signal of the corresponding oscillator system to generate a mixed signal; and
means for performing residual sideband (RSB) calibration of the first one of said plurality of signal paths based on the mixed signal.

27. The apparatus of claim 26, wherein in each of the plurality of oscillator systems the means for generating are configured to generate a first oscillating signal and a second oscillating signal,
wherein the oscillating signal based on which the mixed signal is generated is the first oscillating signal from the oscillator system coupled to said first one of said plurality of signal paths, and
wherein the oscillating signal based on which the tone signal is generated is the second oscillating signal from the oscillator system corresponding to the another one of the plurality of signal paths.

28. The apparatus of claim 27 further comprising means for switching the plurality of signal paths to a frequency interleaved calibration mode or to a time interleaved calibration mode, wherein in the frequency interleaved calibration mode, the apparatus further comprising means for calibrating the first one and the another one of the plurality of signal paths in parallel, and wherein, in the time interleaved calibration mode, the means for calibrating are configured to calibrate the first one and the another one of the plurality of signal paths one after the other.

29. The apparatus of claim 28, wherein, in the time interleaved calibration mode, the means for switching are configured to disable the generation of the second oscillating signal of the oscillator system coupled to the first one of said plurality of signal paths, means for generating the tone signal of the first one of said plurality of signal paths, and the means for generating the first oscillating signal of the another one of said plurality of signal paths.

30. The apparatus of claim 28, wherein, in the frequency interleaved calibration mode, means for mixing of said another one of said plurality of signal paths is configured to generate another mixed signal based on a tone signal from means for generating a tone signal of said first one of the plurality of signal paths and the first oscillating signal from the oscillator system coupled to said another one of said plurality of signal paths.
